(19) United States
(12) Patent Application Publication
(10) Pub. No.: US 2025/0238001 A1
(43) Pub. Date: Jul. 24, 2025

(54) METHOD FOR DECORATING A TIMEPIECE COMPONENT

(71) Applicant: MANUFACTURE D'HORLOGERIE AUDEMARS PIGUET SA, Le Brassus (CH)

(72) Inventor: Nicolas PONSOT, Arzier-Le Muids (CH)

(73) Assignee: MANUFACTURE D'HORLOGERIE AUDEMARS PIGUET SA, Le Brassus (CH)

(21) Appl. No.: 18/868,105

(22) PCT Filed: Jun. 1, 2023
(86) PCT No.: PCT/IB2023/055623

§ 371 Date: Nov. 21, 2024

(30) Foreign Application Priority Data
Jun. 3, 2022 (EP) 22177156.1

(51) Int. Cl. G04D 3/00; G04B 19/10; G04B 19/12

(52) U.S. Cl. CPC G04D 3/0092; G04B 19/10; G04B 19/12; G04D 3/0069

(57) ABSTRACT

A method for decorating a timepiece component, particularly a skeleton type watch dial. The component includes at least two different visual appearances, each visual appearance being the unique combination of a surface finish and of a colour. The decoration has the following steps: i) providing a component blank with a first unfinished surface (10a); ii) creating on said first unfinished surface a first termination possessing a first surface finish; iii) applying to the first termination one or more layers of atoms so as to give the first termination a first colour; iv) creating a second termination having at least one breaking of a corner on the blank in order to form at least one bevel or at least one chamfer having a second unfinished surface; v) creating on said second unfinished surface a second termination conferring a second surface finish, and vi) using electroplating, PVD or ALD, to deposit a metallic layer, preferably a layer of rhodium or of gold, on the second termination so as to give the second termination a second colour.

### TECHNICAL FIELD

The present invention relates generally to a method for decorating a component with several surface treatments. The method is particularly suitable for decorating a skeleton-type dial. The invention also relates to a timepiece comprising one or more watch components obtained according to the method for decorating a component, in particular a skeleton-type dial, a movement plate, one or more bridges and/or an oscillating weight.

### STATE OF THE ART

It is known to decorate the surface of a watch component, such as a dial, a bridge or a plate of a movement, to give it an interesting visual appearance. In particular, the surface of the component is worked to give it a certain structure, traditionally by processes such as brushing, circular graining, satin-finishing or sandblasting. Such an approach involves a single step of machining the surface to be decorated in order to obtain the desired visual effect. This step can be combined with other steps to apply a thin layer of colour using, for example, a PVD or electroplating process.

By way of example, EP3220212 discloses a process for decorating a watch component comprising a step of preparing the watch component, a step of corrosion protection, and a step of colouring to form an external decorative coloured layer. CH711122 discloses for its part a process for producing a decorative coating having a white coloured surface obtained by a superposition of layers deposited using galvanic and CVD processes.

The decorative possibilities offered by these processes are limited to a restricted choice from among a few well-known solutions, which does not make it possible to offer original decorative solutions.

Furthermore, known decoration processes must meet high quality criteria so that the decorated component can withstand the stresses to which a watch, in particular a sport watch, is likely to be subjected, in particular shocks and accelerations. For this reason, the number of steps in known processes is reduced in order to limit production costs.

CH717065 discloses a method of manufacturing a watch component which allows a range of variations to be made from both the technical and aesthetic points of view. In particular, the manufacturing process involves machining the timepiece component to form an essentially flat face and at least one flank bordering the essentially flat face. A chamfered edge is then machined at a junction between the essentially flat face and the flank, followed by a coating applied directly to the rough surface of the chamfered edge.

An aim of the present invention is to provide a method for decorating a timepiece component, which enables to give the component a wider range of different visual appearances.

Another aim of the present invention is to propose a method for decorating a component, in particular a watch dial, especially of the skeleton type, increasing the visual quality of the component.

An additional aim of the present invention is to provide a component, in particular a watch dial, especially of the skeleton type, which is resistant to the stresses likely to be endured by a watch, in particular a sport watch.

### BRIEF SUMMARY OF THE INVENTION

These aims are achieved in particular by a method for decorating a component comprising at least two different visual appearance. Each visual appearance is the unique combination of a surface finish and of a colour. The decoration method comprises the following steps: i) providing a component blank comprising a first unfinished surface; ii) performing on said first unfinished surface a first termination possessing a first surface finish; iii) applying to the first termination one or more layers of atoms so as to give the first termination a first colour; iv) performing at least one angle breaking on the blank in order to form at least one bevel or at least one chamfer comprising a second unfinished surface; v) performing on said second unfinished surface a second termination possessing a second surface finish, and vi) using electroplating, PVD or ALD, to deposit a metallic layer, preferably a layer of rhodium or of gold, on the second termination so as to give the second termination a second colour (22).

According to an embodiment, the decoration method further comprises, between step iii) and step iv), a step consisting in applying a sacrificial protective layer to the first colour. This sacrificial protective layer is removed after step vi).

According to an embodiment, the component is selected from a bridge, a plate, an oscillating weight, a dial with one or more windows and a skeleton-type dial. The dial may also include indexes.

According to an embodiment, the watch component is made of a copper alloy such as nickel silver, steel such as 316L steel, Durnico®, etc., ceramic or precious metal such as gold, platinum or palladium.

According to an embodiment, the first termination is obtained by sandblasting, bead blasting, satin-finishing of the straight, circular or spiral type, azure-finishing, hammering of the manual or mechanical type, guillochage, circular graining, côte de Genève finish, hand engraving or polishing.

According to an embodiment, the second termination is obtained by straight satin-finishing, planing, hand-bevelling, hand-engraving or sandblasting.

According to an embodiment, step iii) consists in carrying out a PVD, ALD or electroplating treatment on the first termination.

Another aspect of the invention relates to a watch component, in particular a bridge, a plate, an oscillating weight, a dial with one or more windows or a skeleton-type dial obtained by the decoration method according to the invention.

According to an embodiment, the component is a skeleton-type watch dial. The latter comprises dial portions and open-worked portions defined by the contour of the dial portions. The dial portions preferably comprise flat surfaces extending in the plane of the dial, and bevels arranged around the open-worked portions. Said dial portions comprise the first termination and the first colour in order to have a first visual appearance. The bevels of the dial have the second termination and the second colour so as to have a second visual appearance different from the first visual appearance.

The invention also relates to a timepiece comprising the component obtained by the method according to the invention, in particular a dial of the skeleton type mentioned above.

### BRIEF SUMMARY OF THE FIGURES

Examples of embodiments of the invention are mentioned in the description illustrated by the appended figures in which:

FIGS. 1a to 1h schematically illustrate the various steps of the decoration method according to a preferred embodiment of the invention, and

FIG. 2 illustrates a view of a skeleton-type watch dial obtained by the decoration method according to an embodiment of the invention.

### EXAMPLES OF EMBODIMENTS OF THE INVENTION

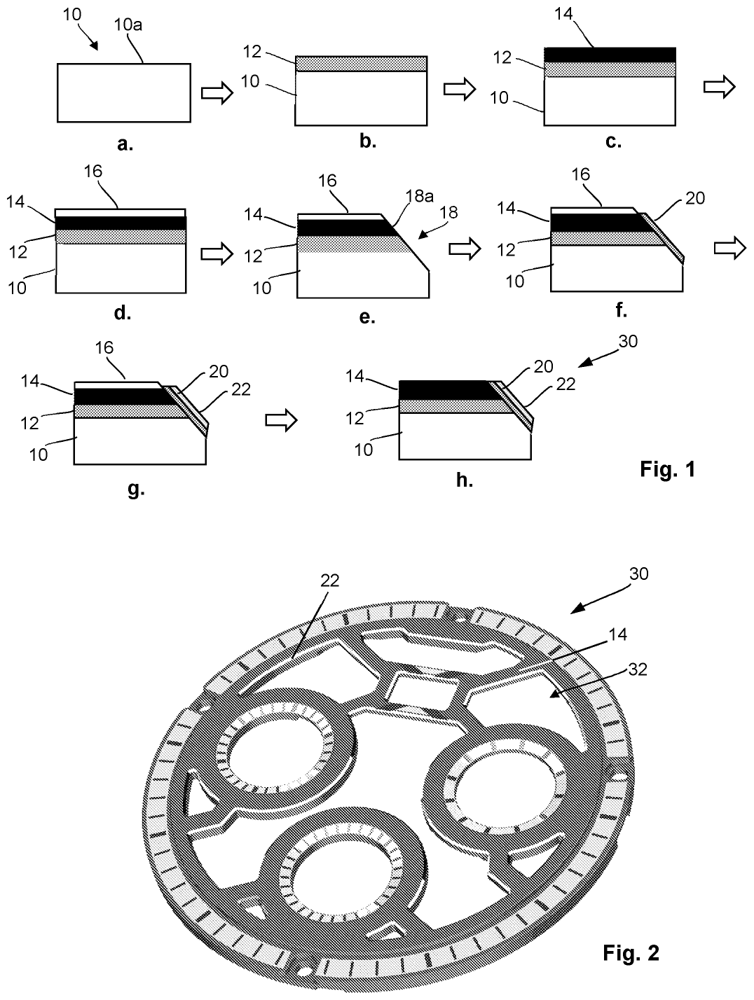

According to a preferred embodiment illustrated by steps 1a to 1g, the method comprises a first step consisting in performing on an unfinished surface 10a of a blank 10 of a watch component, a first decoration operation in order to obtain a first termination 12 according to FIG. 1b.

For a skeleton-type dial illustrated in FIG. 2, the method comprises a step prior to the decoration operation which consists in carrying out open-worked parts 32 on a dial blank which is in the form of a solid disc comprising an unfinished surface. This operation is preferably carried out by wire-cut EDM (Electrical Discharge Machining) process.

The component blank 10, in particular the dial blank, is preferably made of copper alloys, in particular nickel silver, capable of withstanding the mechanical stresses, in particular the accelerations to which a sport watch may be subjected.

The first termination 12 is carried out on the unfinished surfaces of the dial portions surrounding the various open-worked parts. These unfinished surfaces are preferably flat and typically extend to the surface of the skeleton dial.

The first termination 12 may be obtained by various decorative techniques, in particular by sandblasting in order to obtain a certain roughness, by satin-finishing consisting of coating the unfinished surface 10a of the blank 10 with a set of extremely thin and parallel stripes, for example straight, circular or spiral stripes in order to catch the light from several angles. Other techniques can be used to work and structure the unfinished surface 10a of the blank 10 in order to give it an original visual appearance, in particular by bead blasting, guilloché, circular graining, côte de Genève finishing, manual or mechanical hammering, hand engraving, polishing or even azure-finishing.

Blanks made of other materials can also be used, in particular steel, for example a low-carbon steel of type 316L in order to avoid corrosion, precious metals, for example in gold, in platinum, in palladium or even in ceramic or titanium.

Once the first termination 12 has been completed, a PVD (Physical Vapour Deposition) treatment is carried out on the first termination 12 in order to deposit a thin film 14 of the desired colour under vacuum (FIG. 1c), in particular in black. An ALD (Atomic Layer Deposition) treatment or an electroplating treatment may also be carried out instead of the PVD treatment to obtain the film 14. A sacrificial protective layer 16 (FIG. 1d) is then applied to the entire dial. This protective layer may, for example, be an epoxy varnish to protect the film 14 from particles produced by the subsequent steps of the decoration method described below.

According to FIGS. 1e and 2, the dial of the skeleton type is then machined in order to cut the angles, for example of the contours of the open-worked portions 32 of the dial, in order to obtain bevels or chamfers 18 which make it possible in particular to reveal the base material (for example nickel silver) which constituted the blank. These bevels or chamfers define the perimeter of the open-worked portions 32 of the dial. A second termination 20 is then carried out on an unfinished surface 18a of the bevels or chamfers 18 (FIG. 1f). As with the first termination 12, the second termination 20 can be obtained by various decorative techniques, in particular sandblasting, straight satin-finishing, planing carried out, for example, using a diamond point, hand-bevelling or hand engraving.

Once the second termination 20 has been produced, a profiling operation is generally performed on the dial to give the dial its final shape.

With reference to FIG. 1g, the profiling operation is followed by an electroplating process which is carried out on this second termination 20 in order to deposit a metallic film 22 of the desired colour. This metallic film is for example a film of rhodium, of gold, of NAC or of black NAC, the black NAC being a deep anthracite-coloured black coating.

A varnish removal operation is then carried out by applying a solvent to the entire dial in order to remove the epoxy varnish protective layer 16. A transfer operation is then carried out on the dial, in particular to create the dial indexes.

The decoration method can also be applied to watch components made of aluminum or in an aluminum alloy, and to watch components made of titanium or in a titanium alloy. For this type of material, an anodizing process can be used to give the first and second terminations a first and second color respectively.

Although the above description mainly describes a decoration method applied to a skeleton-type dial, the method can be applied to any other watch component comprising a main surface, preferably flat, as well as one or more bevels or chamfers. This method can therefore be applied in particular to a bridge, to the plate of a watch movement, to the oscillating weight of an automatic movement or to a dial comprising indexes and/or one or more bevelled or chamfered windows.

Moreover, the coloring of the first and second terminations 12, 20 can be carried out with the same method according to a variant of embodiment. For example, the first and second terminations 12, 20 can both undergo a PVD/ALD treatment or a galvanic treatment. Care must be taken, however, to ensure that the parameters of these treatments differ between the first and second terminations 12, 20.

The dial 30 of FIG. 2 thus comprises two different visual appearances, each visual appearance being the unique combination of a surface finish and of a colour.

1. Method for decorating a timepiece component, the component comprising at least two different visual appearances, each visual appearance being the unique combination of a surface finish and of a colour, the decoration method comprising the following steps:
i) providing a component blank comprising a first unfinished surface;
ii) performing on said first unfinished surface a first termination possessing a first surface finish;
iii) applying to the first termination one or more layers of atoms so as to give the first termination a first colour;
iv) performing at least one angle breaking on the blank in order to form at least one bevel or at least one chamfer comprising a second unfinished surface;
v) performing on said second unfinished surface a second termination possessing a second surface finish, and vi) using electroplating, PVD or ALD, to deposit a metallic layer on the second termination so as to give the second termination a second colour.

2. Decorating method of claim 1, further comprising, between step iii) and step iv), a step consisting in applying a sacrificial protective layer to the first colour, said sacrificial protective layer being removed after step vi).

3. Decorating method of claim 1, wherein the component is selected from a bridge, a plate, an oscillating weight, a dial with one or more windows and a skeleton-type dial.

4. Decorating method of claim 1, wherein the component is made of steel, gold, platinum, palladium, ceramic or copper alloy, in particular nickel silver.

5. Decoration method of claim 1, wherein said first termination is obtained by sandblasting, bead-blasting, satin-finishing of the straight, circular or spiral type, azure-finishing, manual or mechanical hammering, guillochage, circular graining, côte de Genève finishing, hand-engraving or polishing.

6. Decoration method of claim 1, wherein said second termination is obtained by straight satin-finishing, planing, hand-bevelling, hand-engraving or sandblasting.

7. Decoration method of claim 1, wherein step iii) consists in performing a PVD, ALD or galvanic treatment on the first termination.

8. Watch component, in particular a bridge, a plate, an oscillating weight, a dial with one or more windows or a skeleton-type dial obtained by the decoration method of claim 1.

9. Watch component of claim 8, in the form of a skeleton-type watch dial, comprising dial portions and open-worked portions defined by the contour of the dial portions, the dial portions comprising a surface and bevels or chamfers adjacent to the surface of said dial portions and arranged around the open-worked portions, said surface having said first termination and said first color to provide a first visual appearance, the bevels or chamfers having the second termination and the second colour to provide a second visual appearance different from the first visual appearance.

10. Timepiece comprising the watch component of claim 9.

11. Decoration method of claim 1, wherein said metallic layer is a layer of rhodium or of gold.
